(19) United States
(12) Patent Application Publication
(10) Pub. No.: US 2005/0053029 A1
(43) Pub. Date: Mar. 10, 2005

(54) Method for performing uplink access in broadband mobile communication system

(75) Inventors: Sung-Jin Lee, Suwon-si (KR); Chang-Hoi Koo, Seongnam-si (KR); Jung-Je Son, Seongnam-si (KR); Yeong-Moon Son, Anyang-si (KR); So-Hyun Kim, Suwon-si (KR); Hyun-Jeong Kang, Seoul (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., GYEONGGI-DO (KR)

(21) Appl. No.: 10/932,393

(22) Filed: Sep. 2, 2004

(30) Foreign Application Priority Data
Sep. 4, 2003 (KR) 61896/2003

(51) Int. Cl. H04Q 7/00

(52) U.S. Cl. 370/328

(57) ABSTRACT

Disclosed is an efficient random access method which enables a subscriber station to gain access to an uplink in broadband mobile communication system including the subscriber station and a base station. The method enables a subscriber station to perform re-access to a base station at a high speed in the mobile communication system, in which an access channel is allocated so that the subscriber station and the base station can transmit a message to each other using a code within a predetermined period of time, wherein, the method includes the steps of: the subscriber station receiving a request rejection message including a dedicated code in response to a request message transmitted from the subscriber station to the base station through the access channel; and the subscriber station checking the received request rejection message, and re-transmitting the request message in a contention-free method corresponding to the dedicated code which is included in the request rejection message.

### PRIORITY

This application claims priority to an application entitled “Method For Performing Uplink Access In Broadband Mobile Communication System,” filed in the Korean Intellectual Property Office on Sep. 4, 2003, and assigned Serial No. 2003-61896, the contents of which are hereby incorporated by reference.

### BACKGROUND OF THE INVENTION

1. Field of the Invention

The present invention relates to a broadband mobile communication system, and more particularly to a uplink channel access method for efficiently transmitting packet data from a subscriber station to a base station in broadband mobile communication system employing an orthogonal frequency division multiplexing (OFDM) method and an orthogonal frequency division multiplexing access (OFDMA) method.

2. Description of the Related Art

Fourth generation (hereinafter, referred to as “4G”) communication systems (the next generation communication system), are being designed to provide users with services having various qualities of service (hereinafter, referred to as “QoS”) and supporting a transmission speed of about 100 Mbps. Current third generation (hereinafter, referred to as ‘3G’) communication systems support a transmission speed of about 384 kbps in an outdoor channel environment having a relatively unfavorable channel environment and support a maximum transmission speed of 2 Mbps in a favorable channel environment (e.g., an indoor channel environment).

Meanwhile, wireless local area networks (hereinafter, referred to as “LAN”) systems and wireless metropolitan area networks (hereinafter, referred to as “MAN”) systems generally support transmission speeds of 20 to 50 Mbps. Accordingly, in current 4G communication systems, research is being actively pursued to develop a new type of communication system which ensures mobility and QoS in wireless LAN system and wireless MAN system which support relatively high transmission speeds and high speed service which are to be provided by the 4G communication system.

Since the wireless MAN system has a wide service coverage and supports a high transmission speed, it is suitable for supporting a high speed communication service. However, the wireless MAN system neither reflects the mobility of a user, i.e. a subscriber station (SS) nor reflects handoff according to high speed movement of the subscriber station.

Hereinafter, a structure of a conventional IEEE 802.16a communication system functioning as a wireless MAN system as described above will be described with reference to FIG. 1.

FIG. 1 a block diagram schematically showing a structure of a system employing an orthogonal frequency division multiplexing (hereinafter, referred to as ‘OFDM’) method and an orthogonal frequency division multiple access (hereinafter, referred to as ‘OFDMA’) method. Specifically, FIG. 1 schematically shows a structure of an IEEE 802.16a communication system.

The wireless MAN system is a broadband wireless access (BWA) communication system, which has a wider service area and supports a higher transmission speed than the wireless LAN system. The IEEE 802.16a communication system is a communication system employing both an OFDM method and an OFDMA method in order to enable a physical channel of the wireless MAN system to support a broadband transmission network. That is, the IEEE 802.16a communication system is a system a broadband wireless access communication system employing an OFDM/OFDMA method. Further, the IEEE 802.16a communication system applies an OFDM/OFDMA method to the wireless MAN system, which allows the IEEE 802.16a communication system to transmit a physical channel signal by means of a plurality of sub-carriers, thereby enabling a high speed data transmission.

Meanwhile, an IEEE 802.16e communication system is a system reflecting mobility of a subscriber station in addition to the IEEE 802.16a communication system, and presently no specific standards have yet to be defined for the IEEE 802.16e communication system yet. In other words, both the IEEE 802.16a communication system and the IEEE 802.16e communication system are broadband wireless access communication systems employing the OFDM/OFDMA method. Hereinafter, for convenience of description, the IEEE 802.16a communication system will be described as an example.

Referring to FIG. 1, the IEEE 802.16a communication system has a single cell structure and includes a base station (BS) 100 and a plurality of subscriber stations 110, 120, and 130 which are controlled by the base station 100. The transmission/reception of signals between the base station 100 and the subscriber stations 110, 120, and 130 are performed according to the OFDM/OFDMA method.

Meanwhile, as described above, the conventional mobile communication system generally uses a random access channel (RACH) for an initial access attempt. That is, when a subscriber station is first powered on and attempts access to a base station of a cell in which the subscriber station is located, when a subscriber station moves from one cell into another cell, or when a subscriber station attempts access a base station to be provided a new service, the subscriber station is not allocated any channel resources, and therefore subscriber station is in a state in which it has been not yet allocated any uplink bandwidth. In this state, the subscriber station must transmit a message through a random channel to the base station to perform uplink access to the base station.

Unlike the above case, when the subscriber station is allocated an uplink bandwidth and performs uplink access, the relevant range of the allocated bandwidth is allocated only to one specific subscriber station. Therefore, the subscriber station can transmit a message to the base station without interference from other subscriber stations. In this case, since the subscriber station transmits a message through a bandwidth which has been allocated to only one subscriber station as described above, the subscriber station can perform uplink access to a base station without contention for acquisition of a right to use an uplink channel with other subscriber stations. Such an access method is called a “contention-free access method”.

In contrast, in the above-mentioned random access method, since a subscriber station tries to transmit a message through a random channel at a random point of time without allocation and reservation for an allocated uplink bandwidth, other subscriber stations in the same cell as that of the subscriber station may also try to transmit messages simultaneously. As described above, when two or more subscriber stations try to perform the random access simultaneously, messages transmitted from the plurality of subscriber stations collide with each other on a wireless channel.

Therefore, in a base station party, it is impossible to distinguish the messages collided as described above. In this case, all the messages transmitted simultaneously are processed as a failure, and the respective subscriber stations wait for a predetermined period of time (back-off time) and again try to access to the base station.

Hereinafter, a configuration of an uplink channel used in a broadband mobile access communication will be described.

FIG. 2 is a view showing a configuration of an uplink channel in a general broadband mobile communication system. The uplink channels are classified into two kinds of channels, that is, a ranging channel 200 and a data channel 210.

The ranging channel 200 includes a range which is used for transmitting a message for a communication service control such as a control message, synchronization, and a bandwidth request between a subscriber station and a base station. A plurality of subscriber stations use a code division multiple access (hereinafter, referred to as “CDMA”) method to simultaneously perform uplink access through the ranging channel 200.

Meanwhile, the data channel 210 is a channel through which the subscriber station transmits an actual data to a base station. As described above, in the case of the data channel 210, a predetermined range divided according to codes or time is allocated to a specific subscriber station. Therefore, the data channel 210 has a dedicated range which does not cause such a collision as generated in the ranging channel 200.

Hereinafter, a message transmission process in the above-mentioned uplink channel configuration will be described.

First, a message transmission process in the ranging channel 200 will be described. When a message, which a subscriber station desires to transmit to a base station, is generated in the broadband mobile access system, the subscriber station selects a random orthogonal code, for example, a pseudo noise (PN) code, and then spreads the transmission message using the PN code, thereby transmitting the message to the base station according to the CDMA method.

In this case, since the PN code is selected by the subscriber station within a predetermined range of code combinations, two or more different subscriber stations may select the same PN code through the PN code selection process. When a receiving unit of the base station receives messages which are spread and are transmitted using the same PN code, the receiving unit cannot distinguish the sender of the received message from among the subscriber stations.

Meanwhile, the conventional random access method uses an ALOHA scheme or a slotted-ALOHA scheme. In the case of using a random access channel according to the two schemes, when a subscriber station is not allocated a bandwidth from a base station, the subscriber station tries to perform a random data transmission (random access) within a predetermined channel range. In this case, data transmission is successfully accomplished when the data transmitted the subscriber station does not collides with data transmitted outputted from other subscriber stations. In contrast, when data transmitted from the subscriber station collides with data transmitted from other subscriber stations, the data transmission fails and the subscriber station has to re-transmit the data in a similar manner within a predetermined channel range after waiting for a random period of time (back-off time).

Moreover, in the transmission of data through random access as described above, when the collisions of data are continuously generated, the transmission of the data is delayed, thereby causing a problem that it is difficult to guarantee the reliability of the access.

The conventional mobile communication system are generally designed for the purpose of providing a single type of service (e.g., for voice communications) and not for the various types of (e.g., data communication service) in the conventional mobile communication system). Therefore, in the conventional mobile communication system, it is unnecessary to distinguish the types of service in a random access' process for the initial access.

As described above, the random access method is used for a subscriber station to perform random access to a base station. However, although the random access to the base station is accomplished, the accomplishment of the random access does not guarantee an allocation of an uplink bandwidth. The base station calculates the total bandwidth requested and received through the random access from all subscriber stations which are located in a cell of the base station, and allocates uplink transmission channels for the next frame to the selected subscriber stations in consideration of the channel environment.

When the sum of bandwidth requested from the subscriber stations is larger than a bandwidth capable of being used now in the base station, the base station can selectively reject the request messages transmitted from the subscriber stations. In this case, if a user again tries to perform access of service, the subscriber station again transmits a message to request the bandwidth allocation, so that the subscriber station must again perform the above-mentioned random access process of contending with other subscriber stations.

Hereinafter, the conventional random access process will be described in detail with reference to FIG. 3.

FIG. 3 is a flow diagram illustrating the conventional random access process in a broadband mobile communication system.

Referring to FIG. 3, a subscriber station 300 transmits an access request message or a bandwidth allocation message to a base station 350 through a contention-based channel (step 311) so as to try to access to the base station 350. In this case, as described above, the random access method permits the subscriber station 300 and other subscriber stations (which are not shown) to transmit the same request message simultaneously, so that messages which are transmitted from the plurality of subscriber stations may collide with each other.

As described above, a collision (as depicted by the “X” drawn through line 311) is generated due to a plurality of messages transmitted from the plurality of terminals The subscriber station 300 then 300 determines that the transmission has failed and waits for a random waiting time (back-off time) (step 313), and then re-transmits the same message (step 315).

In this case, a collision may again occur due to the same reason. At this time, the subscriber station 300 determines that the transmission has once again failed and waits for a random waiting time (back-off time) (step 317), and then may transmit the request message, for example, a bandwidth allocation request message to the base station 350 through the third re-transmission (step 319).

As described above, since a random access range permits all subscriber stations within the cell to attempt accessing the base station through the random access range, the greater the number of subscriber stations located within the cell area, the more frequently collisions are generated. This causes a commensurate delay in accessing the available service and also reduces the quality of service provided.

Meanwhile, FIG. 3 also shows a case in which the transmission of the request message to the base station is accomplished through the two re-transmissions but now the base station does not allocate a bandwidth according to a service request received from the subscriber station 300 due to lack of resources in a base system and a wireless channel range (step 321). In this case, the base station 350 transmits a message to reject service provision to the subscriber station 300 (step 323). That is, although the subscriber station 300 accomplishes access with difficulty through re-transmission as described above, the base station 350 may reject the access request according to the channel resource environment of the base station 350.

Therefore, the subscriber station 300, which has received an access request rejection message (e.g., a bandwidth request rejection message), must again perform a message transmission process through a random access channel, as performed in the above-mentioned initial access trial. As described above, although a subscriber station, which tries to perform random access without regard to the types or priorities of service, accomplishes the transmission of the request message, the subscriber station must again begin the same access trial process from the very beginning if the request is rejected due to lack of current available resources.

Meanwhile, as described above, in the fourth generation (hereinafter, referred to as “4G”) communication system (the next generation communication system) research is being actively pursued to provide users (i.e., a plurality of subscriber stations) with services having various QoSs and supporting a transmission speed of about 100 Mbps. The distinguishing characteristic of the 4G communication system is that it provides various services through data communication, so that the conventional voice service will be included as one of the various services in the 4G communication environment.

As described above, in the 4G communication environment, various types of services currently exist and it is expected that new services will be developed continuously. Such various types of services have a real time characteristic or a non-real time characteristic, and will have to be classified according to various priorities. However, when the conventional random access method (as described above) is applied to the above-mentioned 4G environment, there is a limitation in supporting the various services.

That is, the 4G communication system provides various services and selects different priorities for request messages transmitted from subscriber stations to a base station. Therefore, a more flexible access method according to the priorities and the like is necessary in access of the subscriber station to the base station, in order to meet environments for such various services.

### SUMMARY OF THE INVENTION

Accordingly, the present invention has been made to solve the above-mentioned problems occurring in the prior art, and an object of the present invention is to provide an uplink channel access method which enables packet data to be transmitted from a subscriber station to a base station in a broadband mobile communication system.

In addition, another object of the present invention is to provide a method for guaranteeing reliable access according to types of services and priorities of data when re-access is performed after a random access is performed in the broadband mobile communication system.

In addition, still another object of the present invention is to provide a method for enabling the performance of fast access, without again performing the same contention process in a random access channel, when re-access is requested in the broadband mobile communication system.

To accomplish this object, in accordance with one aspect of the present invention, there is provided a method for a subscriber station to perform re-access to a base station at a high speed in a wireless communication system, in which an access channel is allocated so that the subscriber station and the base station can transmit a message to each other using a code within a predetermined period of time. The method comprises the steps of receiving a request rejection message from the base station including a dedicated code in response to a request message transmitted from the subscriber station to the base station through the access channel; and re-transmitting the request message according to a contention-free method corresponding to the dedicated code included in the request rejection message.

In accordance with another aspect of the present invention, there is provided a method for a subscriber station to perform re-access to a base station at a high speed in a wireless communication system, in which an access channel is allocated so that the subscriber station and the base station can transmit a message to each other using a code within a predetermined period of time. The method comprises the steps of receiving a request rejection message from the base station including dedicated time slot information in response to a request message transmitted from the subscriber station to the base station through the access channel; and re-transmitting the request message using a contention-free method corresponding to the dedicated time slot information included in the request rejection message.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram schematically illustrates a structure of a system employing an orthogonal frequency division multiplexing (OFDM) method and an orthogonal frequency division multiple access (OFDMA) method;

FIG. 2 is a view showing a configuration of an uplink channel in a general broadband mobile communication system;

FIG. 3 is a flow diagram illustrating the conventional random access process in a broadband mobile communication system;

FIG. 4 is a flow diagram illustrating an uplink access process in a broadband mobile communication system according to an embodiment of the present invention;

FIG. 5 is a flowchart illustrating a process performed in a base station apparatus so as to achieve uplink access according to an embodiment of the present invention; and

FIG. 6 is a flowchart illustrating a process performed in a subscriber station apparatus so as to achieve uplink access according to an embodiment of the present invention.

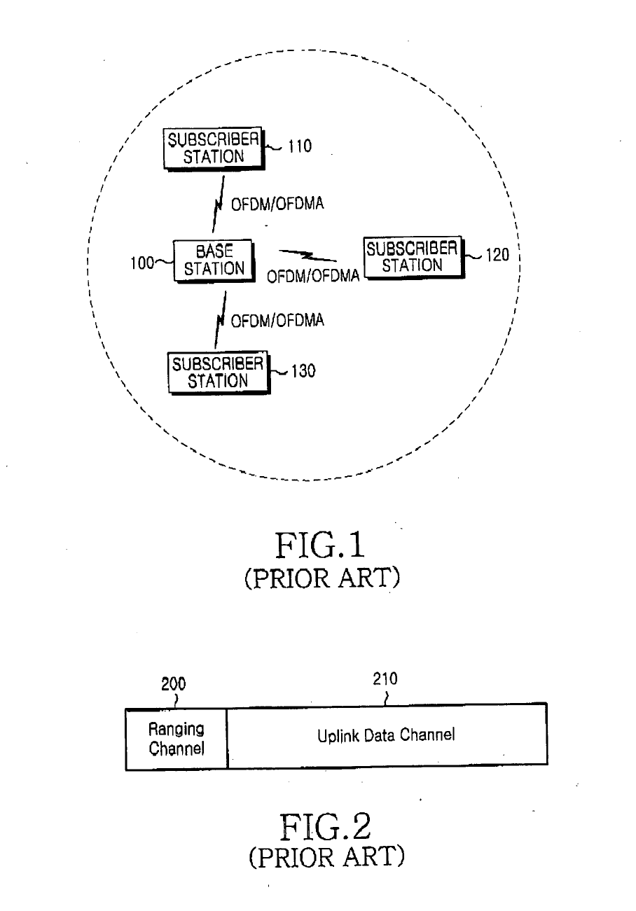

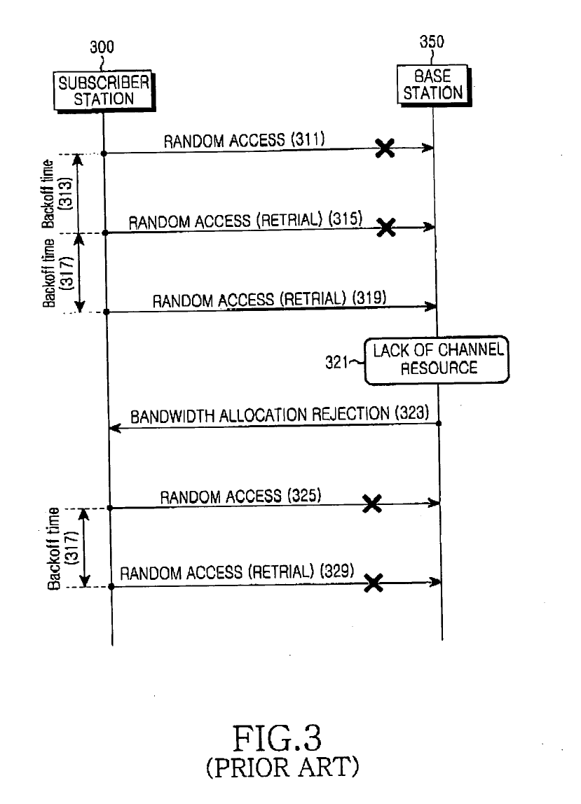

### DETAILED DESCRIPTION OF THE PREFERRED EMBODIMENT

Hereinafter, one preferred embodiment of a method for performing uplink access in a broadband mobile communication system according to the present invention will be described with reference to the accompanying drawings. In the following description of the present invention, a detailed description of known functions and configurations incorporated herein will be omitted when it may make the subject matter of the present invention unclear.

The present invention described hereinafter can be applied to all communication systems which can employ a random access method in which a plurality of subscriber stations try to perform initial access or a bandwidth request through a shared channel. The present invention enables a subscriber station to gain access to base station more efficiently, when the subscriber station tries to perform random access to a base station so as to transmit data in a state in which the subscriber station is not allocated a predetermined bandwidth or a dedicated channel for data transmission.

Meanwhile, in the case of using a normal random access method, although a subscriber station succeeds in the random access, a request of the subscriber station through the random access may be rejected due to lack of channel resources in the base station. In this case, the prior art requires that the subscriber station again attempt the random access in the same way, thereby delaying access of the subscriber station even though the subscriber station requests a service having a high priority. Also, the prior art method decreases the reliability of access due to repeated re-accesses through the random access.

In contrast, according to the present invention, when access is accomplished using the random access method (also known as random access), the reliability of re-access is given according to priorities. That is, according to the present invention, although a request of the subscriber station may be rejected due to lack of channel resources after access is accomplished as described above, contention-free access is guaranteed for the following re-access—unlike the prior art in which re-access is performed through random access—so that the reliability of re-access is guaranteed.

First, prior to a description of the present invention, a configuration of an uplink channel employed in the present invention will be described with reference to Table 1, which is shown below.

Table 1 shows a configuration of an uplink channel which is used in a random access method according to the present invention.

TABLE 1

| PHY | Purpose | |
|---|---|---|
| Access channel | Contention-based | Common channel |
| (UL-ACH) | (Network entry, BW request) | |
| | Contention-free | Common channel |
| Traffic channel | Burst traffic channel | Shared by scheduling |
| (UL-TCH) | (Burst based dynamic allocation) | |
| | Dedicated traffic channel | Highest fixed |
| | (Guaranteed fixed allocation) | allocation |
| | Signaling information | Dedicated channel |

As shown in Table 1, uplink physical channels are classified into access channels (UL-ACH) and traffic channels (UL-TCH). In addition, the physical channels are classified into multiple logical channels.

For example, the access channels are classified into two logical channels. That is, they are classified into a contention-based common channel and a contention-free common channel (fast access channel). The traffic channels are also classified into three logical channels, that is, into a burst traffic channel which is shared by scheduling, a dedicated traffic channel which is peculiarly allocated to each subscriber station, and a signaling information channel for transmitting control information of the data channels.

Hereinafter, the physical channels and the logical channels included in the each physical channel will be described in more detail.

1) Access channel (UL-ACH): A channel used by a subscriber station when the subscriber station transmits a bandwidth allocation request signal to request bandwidth allocation for the purpose of transmitting data through an uplink. According to the grades of the subscriber stations or the characteristics of data traffic to be transmitted, the access channels are classified into the channels as described below.
Contention-based access channel: Managed using a contention-based method, and may be used for a network entry process of a subscriber station or for a bandwidth allocation request. It is also possible to transmit very short data, such as ACK/NACK of TCP (Transmission Control Protocol), together with the access channel request signal (Access Preamble+packet data).

Meanwhile, for the access channel, a transmitting party of the subscriber station selects a random orthogonal code, for example, a PN code, and spreads a message to be transmitted with the random orthogonal code and then transmits this data to a base station. A subscriber station which has received (i.e., a receiving party of the base station) messages spread by the selected random orthogonal code, demodulates the received signals using the respective PN codes and then checks a PN code used each message, thereby distinguishing between messages according to the identification of individual subscriber stations transmitting messages.

In the case of using the random access method, subscriber stations combine the PN codes within a combination range of the PN codes, which may be selected by the subscriber stations, according to types and priorities of messages to be transmitted. Thus, the probability that different subscriber stations select the same PN code may be variable.

However, in general, since demand of subscriber stations is much greater than the number of selectable PN codes in the access code, the respective subscriber stations strive to select different PN codes from each other so as to avoid collision caused by selection of the same PN code.
Fast access channel: A channel which enables a subscriber station to access to a base station in a contention-free method. When the subscriber station accesses the base station, the subscriber station transmits a message using a CDMA multiple access method. The subscriber station can access to the base station only when the subscriber station is allocated with an orthogonal code (a code capable of providing an orthogonality, such as a PN code or a long code), a predetermined time slot position, or the like from the base station.

When a subscriber station desires to gain access to a base station through the fast access channel, the subscriber station can access through the fast access channel using a PN code allocated from the base station as the method proposed in the present invention, but the subscriber station cannot access through the fast access channel using a random PN code which is selected by the subscriber station itself. In this case, since the subscriber station can gain access to the base station only when the subscriber station has been allocated an orthogonal code, for example, a PN code, from the base station, there is no chance that two or more subscriber stations will gain access to the base station simultaneously using the same PN code. Therefore it is always guaranteed that one PN code is used by one subscriber station at one time. Therefore, by using the fast access channel the subscriber station is capable of gaining access to the base station without contention, which may cause collision with another subscriber station, when the subscriber station gains access to the base station.

2) Traffic channel (UL-TCH): A channel for transmitting actual packet data from a subscriber station to a base station. The traffic cannels are classified as described below according to the characteristics of packet data to be transmitted.
Burst traffic channel: A channel for transmitting burst traffic. The burst traffic channel is transmitted using a time-shared method so as to provide a burst-based dynamic allocation function based on dynamic scheduling. Through the burst traffic channel, a real time service can be densely scheduled to be transmitted and a non-real time service and packet data having a best effort characteristic can be transmitted.
Dedicated traffic channel: A channel for allocating the minimum bandwidth fixedly as a priority. Services, such as unsolicited-granted service (UGS), to which a minimum bandwidth is continuously allocated is transmitted in a dedicated allocation method. That is, the subscriber station transmits only a request signal through the access channel, and the subscriber station performs a channel change into the traffic channel and can transmit packet data through the traffic channel when the subscriber station has received a grant signal from the base station.
Signaling channel: A channel for transmitting a signaling message from a subscriber station to a base station.

The above description has shown the respective logical channels and the respective physical channels employed in the present invention. Hereinafter, an efficient uplink access control method which is proposed in the present invention will be described with reference to the accompanying drawings. In the following description, the channels required for uplink access, as described with reference to Table 1, will be used for performing efficient random access and fast re-access processes according to the present invention.

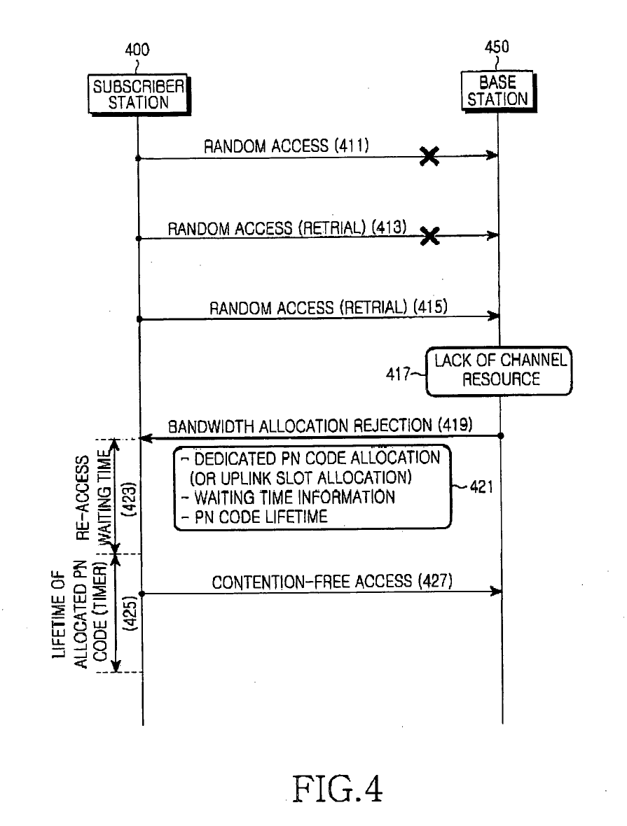

FIG. 4 is a flow diagram of an uplink access process in a broadband mobile communication system according to an embodiment of the present invention.

Prior to the description of FIG. 4, it should be noted that a method for performing an efficient fast contention-free access process after random access is proposed in the present invention which may be applied to all cases in which a subscriber station tries to access to a base station through the random access. For example, when a subscriber station tries to access to a base station through the random access method so as to request a bandwidth allocation to the base station, or so as to perform a hand-over to the base station. Hereinafter, for the convenience of description, the case in which the subscriber station tries the random access so as to request a bandwidth allocation to the base station will be described as an example.

Referring to FIG. 4, a subscriber station 400 transmits a bandwidth request message to a base station 450 through an access channel (UL-ACH) so as to transmit data though an uplink or to request a required uplink bandwidth (step 411). The access channel is a contention-based access channel for an uplink as described with reference to Table 1.

FIG. 4 shows a case in which collision occurs due to other subscriber stations, which simultaneously attempt access, during the first access trial of the subscriber station 400. Therefore, it is shown that the subscriber station 400 fails in the message transmission.

In this case, after the subscriber station 400 waits for a random back-off time according to the characteristic of the random access, the subscriber station 400 transits the same bandwidth request message as that transmitted at the first access trial, to the base station 450 (step 413). However, in this case as in the first access trial, a collision may occur due to other subscriber stations which try to access to the base station 450 simultaneously. Therefore, similarly in the case of the second access trial, the subscriber station 400 waits for a random back-off time and then again tries to access to the base station 450 (step 415).

Meanwhile, when the subscriber station 400 succeeds in the third re-access trial, when the bandwidth request message is normally transmitted to the base station 450 without collision with other signals transmitted from other subscriber stations, the base station 450 can successfully receive and normally demodulate the bandwidth request message transmitted from the subscriber station 400, (step 415).

However, in spite of the fact that an access request signal transmitted from the subscriber station 400 is normally transmitted to the base station 450, a case in which there is no available bandwidth to provide the bandwidth requested from the subscriber station 400 may occur when the channel resources or the system resources of the base station 450 are insufficient (step 417). In this case, the base station 450 transmits a bandwidth request rejection message to the subscriber station 400 which has succeeded in access (step 419).

According to the prior art, when the bandwidth request from a subscriber station is rejected by a base station due to lack of channel resources and the bandwidth request rejection message is transmitted to the subscriber station 400 as described above, the subscriber station 400 is not allocated a bandwidth, and must again perform the bandwidth allocation request process using the above-mentioned random access method when the subscriber station 400 again access to the base station. Therefore, although the subscriber station 400 succeeds in access with difficulty through the random access method as described above, when the subscriber station 400 receives a reject message, the subscriber station 400 must again try to access to the base station using the random access method.

In contrast, according to the present invention, when an the access succeeds and the base station 450 normally demodulates a message, the base station 450 allocates an dedicated orthogonal code (dedicated PN code) or a dedicated time slot (uplink slot) to the subscriber station 400 having succeeded in accessing the base station so that the subscriber station 400 may access at a fast speed without delay, which may occur when using the random access, in a following access trial. Therefore, although the subscriber station 400, which has succeeded in the access, is not allocated a bandwidth as described above, the subscriber station 400 is allocated the dedicated orthogonal code or dedicated time slot, so that it is guaranteed that the subscriber station 400 can perform a fast access through contention-free access with respect to the following access trial.

That is, as described above, when the base station 450 transmits a bandwidth request rejection message to the subscriber station 400, which succeeds in access but is not allocated a bandwidth due to lack of channel resources, the base station 450 transmits the bandwidth request rejection message with a dedicated orthogonal code or a dedicated time slot included in the bandwidth request rejection message so that the following access trial of the subscriber station 400 may be performed at a fast speed.

In the case in which the subscriber station 400 performs re-access not by using a random access method but by using a contention-free access method, if the method according to the present invention is applied to an OFDM system, the base station 450 has to allocate a dedicated orthogonal code, for example, a dedicated PN code, to the subscriber station 400 so that the subscriber station 400 may gain access to the base station 450 through a fast access channel in the following access. Also, if the method according to the present invention is applied to a system employing a Time Division Duplexing (hereinafter, referred to as “TDD”) method, the base station 450 has to allocate a portion of time slots of uplink to the subscriber station 400 so that the subscriber station 400 may exclusively use the portion of allocated time slots.

That is, when the base station 450 transmits a bandwidth request rejection message to the subscriber station 400, which succeeds in access but is not allocated a bandwidth due to lack of channel resources (step 419), the base station 450 transmits the bandwidth request rejection message with the dedicated orthogonal code (for example, a dedicated PN code) or dedicated time slot information included in the bandwidth request rejection message.

In this case, since the dedicated orthogonal code is a limited resource managed by the base station 450, it is inefficient in view of resource management to continuously allocate the dedicated orthogonal code to the subscriber station 400. Therefore, it is preferred (for the base station 450) that the base station 450 allows a dedicated orthogonal code, which is allocated from the base station 450, to be used only during a predetermined period of time and then withdraws the dedicated orthogonal code. Therefore, the base station 450 may allocate a lifetime for using the dedicated orthogonal code simultaneously when the base station 450 allocates and transmits the dedicated orthogonal code to the subscriber station 400. In addition, it is necessary that the base station 450 notifies the subscriber station 400, which receives the bandwidth request rejection message, of how long the subscriber station 400 must wait before trying re-access.

Meanwhile, the parameters newly included in a response message (for example, a bandwidth request rejection message) transmitted from the base station 450 according to an embodiment of the present invention are as follows.

1) Dedicated PN code: An orthogonal code which is allocated to be used when the subscriber station 400 accesses to an uplink through the above-mentioned fast access channel. The subscriber station 400 can perform contention-free access through the dedicated PN code which has been allocated, so that fast re-access of the subscriber station 400 can be guaranteed.

2) Waiting time: Including information about how long the subscriber station 400 waits from when the subscriber station 400 receives a response message (for example, a bandwidth request rejection message) transmitted from the base station 450, before the subscriber station 400 performs re-access. The subscriber station 400 checks the waiting time information, and can perform fast re-access using the dedicated orthogonal code, which has been allocated to the subscriber station 400, after the waiting time elapses.

3) Dedicated PN code lifetime: A lifetime for the dedicated PN code for which the subscriber station 400 is allowed to use the dedicated PN code allocated to the subscriber station 400. That is, the subscriber station 400 is allowed to use the dedicated PN code having been allocated to the subscriber station 400 during the allocated lifetime from when the waiting time elapses.

As described above, when the subscriber station 400 gains access to the base station 450 through an access channel which is a random access channel based on bandwidth contention, if resources to be allocated to the subscriber station 400 are lacking, the base station 450 can reject a request of the subscriber station 400.

In a state of “lack of channel resources” as described above, when the subscriber station 400 transmits a request message for a normal service having a low priority, the base station 450 may one-sidedly transmits only a rejection message in response to a service request of the subscriber station 400. However, when the subscriber station 400 transmits a request message for a service having a high priority, it is preferred that a control is performed so that fast uplink access according to the present invention may be achieved as described above.

Therefore, first, with respect to a service request having a high priority from among messages which are transmitted from subscriber stations accessing access to the base station 450, the base station 450 determines a waiting time for which the subscriber station 400 has to wait before the subscriber station 400 attempts to re-access, a dedicated PN code which is a resource for the subscriber station 400 to perform re-access in a contention-free access method and a lifetime for which the dedicated PN code can be used, in consideration of channel and system circumstances. Then, the base station 450 transmits the bandwidth request rejection message, which includes the determined waiting time, dedicated PN code and lifetime (step 421).

Next, the subscriber station 400 receives the dedicated PN code, the waiting time information, the dedicated PN code lifetime information through the bandwidth request rejection message from the base station 450 (step 21), and waits for the waiting time, not trying re-access, according to the received waiting time information (step 423).

Subsequently, when the waiting time for the re-access elapses (step 423), the subscriber station 400 performs contention-free access to the base station 450 within the allocated dedicated PN code lifetime using the allocated dedicated PN code (step 427). That is, since the subscriber station 400 has already been allocated a dedicated PN code from the base station 450, the subscriber station 400 performs the following access trial not in a random access method of the prior art but in a contention-free access method. Therefore, the subscriber station 400, which succeeds in access but is not allocated a bandwidth due to lack of channel resources, etc., can be guaranteed fast access through contention-free access according to the present invention when the subscriber station 400 tries re-access.

Meanwhile, it is preferred that dedicated orthogonal code allocation according to the present invention is applied to subscriber stations which request a service having a high priority. For example, the base station 450 can determine whether or not the base station 450 allocates the dedicated orthogonal code by judging whether the subscriber station 400 requests a premium data transmission service which requires a high rental fee, or requests transmission of urgent data, or others, according to information pre-stored in the base station 450 or request information transmitted from the subscriber station 400.

To be brief, the subscriber station 400, which has been allocated a dedicated PN code in step 419 in FIG. 4, waits for a waiting time allocated from the base station 450 and then tries re-access within the time period of the allocated PN code lifetime. However, as described above, an access trial to the base station 450 in step 427 is performed not through a random access channel of a contention-based method as (is used in steps 411, 413, and 415), but through a fast access channel of a contention-free method using a dedicated PN code having been allocated from the base station 450.

The method of performing re-access through a fast access channel of a contention-free section using a dedicated PN code, which has been allocated from the base station after the subscriber station failed to receive an allocation in response to a bandwidth allocation request as described above, includes not only the access method using the PN code, but also an access method using either an orthogonal code (e.g., a code capable of providing an orthogonality, such as a PN code, a long code, etc.) or exclusively allocated time slot position information.

Therefore, in the case in which it is not the dedicated PN code but the dedicated time slot which is used to allow access, to a contention-free section depending on various kinds of systems, it is preferred that the base station 450 allocates not only a dedicated PN code but also a dedicated time slot as well, which can be exclusively used by the subscriber station 400 in step 419, so as to be used during the lifetime (step 425) after the waiting time elapses (step 423).

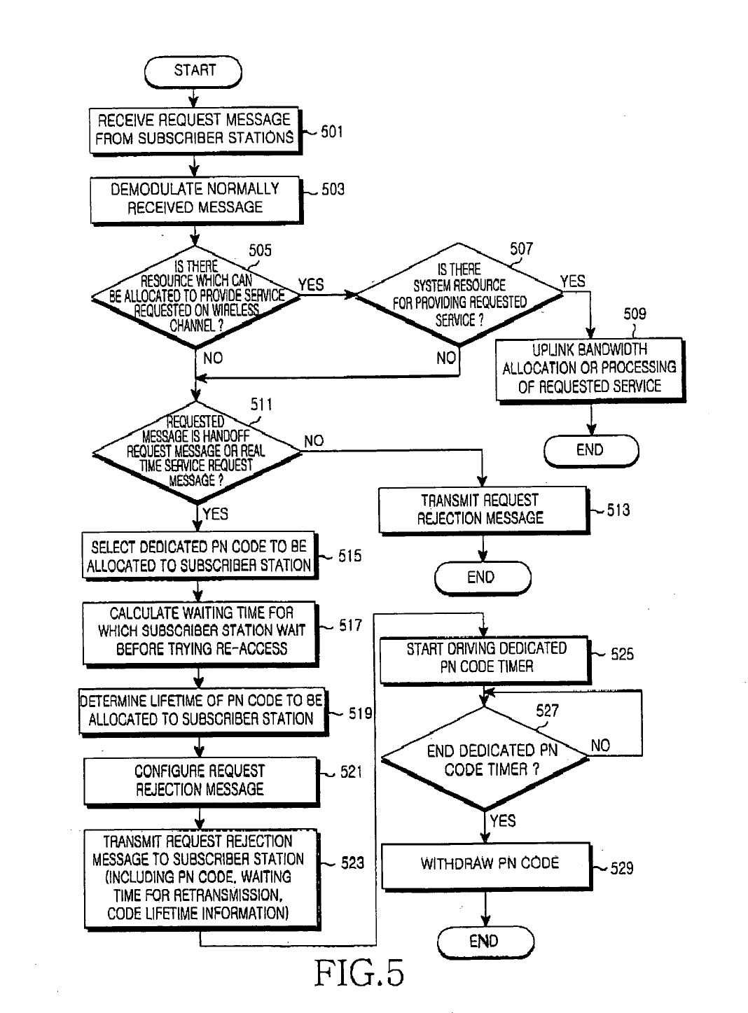

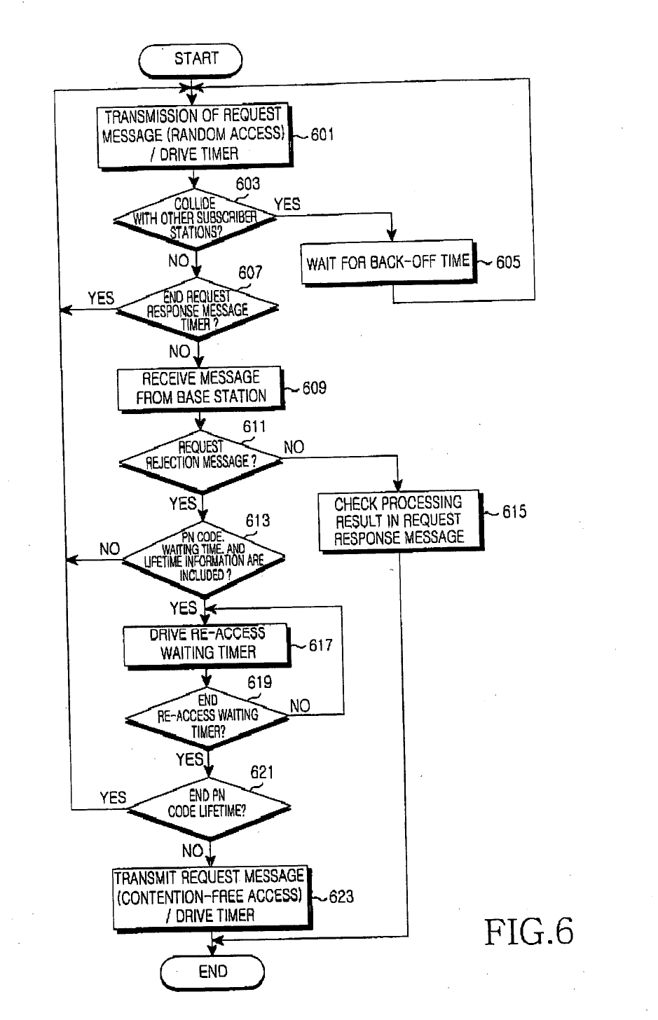

The above description has illustrated the signal transmission process between a subscriber station and a base station according to the present invention with reference to FIG. 4. Hereinafter, processes performed in a subscriber station and a base station according to the present invention will be described in detail with reference to FIGS. 5 and 6, respectively.

FIG. 5 is a flowchart for explaining a process performed in a base station apparatus so as to achieve uplink access according to an embodiment of the present invention. First, a base station receives a plurality of request messages transmitted from a plurality of subscriber stations (step 501). In this case, it is assumed that the request messages transmitted from the subscriber stations are data transmitted through a random access channel. The base station normally demodulates a specific request message (transmitted from a specific subscriber station) only when data corresponding to the specific request message, which is transmitted through the random access channel, does not collide with other data that is transmitted through the random access channel (step 503).

Subsequently, the base station, which has demodulated the received message, determines whether or not there are any remaining resources which can be allocated to provide a requested service on a wireless channel (step 505). As a result of this determination, when there are remaining resources which can be allocated to provide the requested service, the base station checks whether or not there is a system resource for providing the requested service (step 507). When there is a system resource for providing the requested service, the base station proceeds to step 509 and either allocates an uplink bandwidth according to the contents of the request message or normally processes the requested service (step 509).

Meanwhile, when there is no remaining resource which can be allocated to provide the requested service, or when there is no system resource for providing the requested service although there is a remaining resource, the base station transmits a request rejection message because the base station does not normally process the requested service (step 513).

In this case, the base station judges whether the base station will allocate a dedicated orthogonal code (or a dedicated time slot) and transmit the request rejection message as proposed in the present invention or the base station will allocate only the request rejection message as in the prior art, according to the priority of the request message. For example, the base station judges whether the request message is a handoff request message or a real time service request message (step 511). As a result of the decision, when the request message is neither a handoff request message nor a real time service request message, it is preferred that the base station transmits only the request rejection message as in the prior art because the request message is not an urgent message (step 513).

Meanwhile, as a result of the judgment in step 511, when the request message is either a handoff request message or a real time service request message, the request message is an urgent message, so that the base station transmits the request rejection message including information about a dedicated orthogonal code or the like according to the present invention, thereby guaranteeing fast access in the following access although the request is now rejected due to the lack of system resources.

In this case, the base station first selects and allocates a dedicated PN code to be allocated to the subscriber station (step 515), and then calculates and determines a waiting time for which the subscriber station must wait before the subscriber station tries re-access (step 517). In addition, the base station determines a lifetime of the dedicated PN code to be exclusively allocated to the subscriber station and allocates the determined lifetime to the subscriber station (step 519).

The base station configures a request rejection message including the dedicated PN code, waiting time information, and PN code lifetime, which are determined to be allocated to the subscriber station (step 521). Then, the base station transmits the request rejection message, which includes the dedicated PN code, waiting time information, and PN code lifetime newly added according to the present invention, to the relevant subscriber station (step 523). At this time, the base station starts driving a dedicated PN code timer so as to check the lifetime of the allocated PN code because the base station allows the use of the dedicated PN code allocated to the subscriber station only for the PN code lifetime (step 525). Next, when the dedicated PN code timer ends, the base station withdraws the PN code allocated to the subscriber station (step 529).

The above description has shown the operation of the base station according to the present invention with reference to FIG. 5.

Hereinafter, an operation of a subscriber station according to the present invention will be described with reference to FIG. 6.

FIG. 6 is a flowchart for explaining a process performed in a subscriber station apparatus so as to achieve uplink access according to an embodiment of the present invention.

Referring to FIG. 6, a subscriber station transmits a request message, for example, a hand-over request message or a bandwidth allocation request message, etc., to a base station in a random access method (step 601). As described above, the request message transmitted from the subscriber station may collide with other messages because the request message is transmitted using the random access method. Therefore, when the transmitted request message collides with other messages transmitted from other subscriber stations (step 603), the subscriber station must again transmit the same request message to the base station (step 601) after waiting for a predetermined back-off time (step 605).

Meanwhile, when the request message transmitted from the subscriber station is normally transmitted, the subscriber station must determine whether or not a request response message timer has ended (step 607). As a result of the determination, when the request response message timer ends, the subscriber station determines that the request message transmitted from the subscriber station is not normally received in the base station and the subscriber station again transmits the request message to the base station (step 601). As a result of the determination in step 607, when the request response message timer does not end, the subscriber station receives a response message from the base station (step 609). That is, when the subscriber station, which has transmitted the request message to the base station, receives a response message from the base station before an available response waiting time set in the request response message timer elapses, the subscriber station determines that the request message is normally processed in the base station. In contrast, when the subscriber station does not receive a response message from the base station until the request response message timer has ended, which means that a collision between messages has occurred, the subscriber station again transmits the request message to the base station.

Next, the subscriber station checks the kind of a received message (step 611). As a result of the checking, when it is determined that the received message is a normal request response message, the subscriber station checks a processing result shown in the received request response message (step 615) and then performs a normal operation.

In contrast, as a result of the checking in step 611, when it is determined that the message, which the subscriber station has received from the base station, is a request rejection message, this means that the request message transmitted from the subscriber station has normally been transmitted to the base station but the request is rejected due to lack of resources in the base station. In this case, as described above, the base station transmits the request rejection message including the above-mentioned addition information (i.e., a dedicated PN code, waiting time information, and dedicated PN code lifetime information, etc.) so that the subscriber station may gain access in a contention-free method when trying re-access. Therefore, when the message, which the subscriber station has received from the base station, is a request rejection message, the subscriber station checks whether or not addition information is included in the request rejection message received from the base station (step 613).

That is, the subscriber station having received the request rejection message checks the request rejection message, thereby checking whether or not the request rejection message includes a dedicated PN code, waiting time information, and dedicated PN code lifetime information (step 613). As a result of the checking in step 613, when the addition information is not included in the request rejection message, the subscriber station tries to access to the base station again in a random access method according to the prior art.

In contrast, as a result of the checking in step 613, when the request rejection message includes the addition information, that is, a dedicated PN code, waiting time information, and dedicated PN code lifetime information, the subscriber station drives a timer according to a waiting time for re-access (step 617). Then, when the waiting time for re-access elapses (step 619), the subscriber station transmits the request message in the contention-fee method by using the allocated dedicated PN code (step 623).

In this case, it is necessary that the subscriber station checks the dedicated PN code lifetime received from the base station (step 621). In a case in which the dedicated PN code lifetime elapses, although the subscriber station has been allocated the dedicated PN code, the subscriber station does not use the dedicated PN code because the dedicated PN code is withdrawn by the base station as described with reference to FIG. 5. Therefore, in this case, the subscriber station must transmit a request message in a random access method (step 601). In contrast, when the lifetime of the dedicated PN code does not elapse after the waiting time for re-access elapses, the subscriber station transmits the request message by the dedicated PN code allocated from the base station (step 623).

As described above, according to the method for performing an uplink access in a broadband mobile communication system according to embodiments of the present invention, bandwidth allocation for data having a high priority, such as real time service, hand-off, etc., as determined by in the system, is first processed so as to be efficiently transmitted perform an uplink access process, so that it is possible to reduce a waiting time required for re-access when a channel is congested.

While the present invention has been shown and described with reference to certain preferred embodiments thereof, it will be understood by those skilled in the art that various changes in form and details may be made therein without departing from the spirit and scope of the invention as defined by the appended claims.

1. A method for a subscriber station to perform re-access to a base station at a high speed in a wireless communication system, in which an access channel is allocated so that the subscriber station and the base station can transmit a message to each other using a code within a predetermined period of time, the method comprising the steps of:
receiving a request rejection message from the base station including a dedicated code in response to a request message transmitted from the subscriber station to the base station through the access channel; and
re-transmitting the request message according to a contention-free method corresponding to the dedicated code included in the request rejection message.

2. The method as claimed in claim 1, wherein the request rejection message received from the base station further includes lifetime information of the dedicated code.

3. The method as claimed in claim 1, wherein the request rejection message received from the base station further includes waiting time information for a period of time during which the subscriber station has to wait in order to re-transmit the request message.

4. The method as claimed in claim 1, wherein the dedicated code is a dedicated PN code exclusively allocated from the base station to the subscriber station.

5. The method as claimed in claim 1, wherein the request message transmitted from the subscriber station to the base station is a handoff request message.

6. The method as claimed in claim 1, wherein the request message transmitted from the subscriber station to the base station is a bandwidth request message.

7. The method as claimed in claim 1, wherein the base station determines whether the request rejection message includes the dedicated code according to information of service requested from the subscriber station.

8. A method for a base station to allow high speed re-access of a subscriber station to the base station in a wireless communication system, in which an access channel is allocated so that the subscriber station and the base station can transmit a message to each other using a code within a predetermined period of time, the method comprising the steps of:
receiving a request message from the subscriber station through the access channel;
transmitting to the subscriber station a request rejection message including a dedicated code in response to the received request message; and
re-receiving the request message transmitted according to a contention-free method from the subscriber station after transmitting the request rejection message.

9. The method as claimed in claim 8, wherein the request rejection message received from the base station further includes lifetime information of the dedicated code.

10. The method as claimed in claim 8, wherein the request rejection message transmitted to the subscriber station further includes waiting time information for a period of time during which the subscriber station has to wait in order to re-transmit the request message.

11. The method as claimed in claim 8, wherein the dedicated code is a dedicated PN code which is exclusively allocated from the base station to the subscriber station.

12. The method as claimed in claim 8, wherein the request message transmitted from the subscriber station to the base station is a handoff request message.

13. The method as claimed in claim 8, wherein the request message transmitted from the subscriber station to the base station is a bandwidth request message.

14. The method as claimed in claim 8, further comprising a step in which the base station determines whether to include the dedicated code in the request rejection message or not according to information of service requested from the subscriber station.

15. A method for a subscriber station to perform re-access to a base station at a high speed in a wireless communication system, in which an access channel is allocated so that the subscriber station and the base station can transmit a message to each other using a code within a predetermined period of time, the method comprising the steps of:
receiving a request rejection message from the base station including dedicated time slot information in response to a request message transmitted from the subscriber station to the base station through the access channel; and
re-transmitting the request message using a contention-free method corresponding to the dedicated time slot information included in the request rejection message.

16. The method as claimed in claim 15, wherein the request rejection message received from the base station further includes lifetime information of the dedicated time slot.

17. The method as claimed in claim 15, wherein the request rejection message received from the base station further includes waiting time information for a period of time during which the subscriber station has to wait in order to re-transmit the request message.

18. The method as claimed in claim 15, wherein the allocated dedicated time slot is selected from among a contention-free access time area within an uplink transmission time area.

19. The method as claimed in claim 15, wherein the request message transmitted from the subscriber station to the base station is a handoff request message.

20. The method as claimed in claim 15, wherein the request message transmitted from the subscriber station to the base station is a bandwidth request message.

21. The method as claimed in claim 15, wherein the base station determines whether the request rejection message includes the dedicated time slot information, according to information of service requested from the subscriber station.

22. A method for a base station to allow high speed re-access of a subscriber station to the base station in a wireless communication system, in which an access channel is allocated so that the subscriber station and the base station can transmit a message to each other using a code within a predetermined period of time, the method comprising the steps of:
receiving a request message from the subscriber station through the access channel;
transmitting to the subscriber station a request rejection message including dedicated time slot information in response to the received request message; and
re-receiving the request message transmitted according to a contention-free method from the subscriber station after transmitting the request rejection message.

23. The method as claimed in claim 22, wherein the request rejection message received from the base station further includes lifetime information of the dedicated time slot information.

24. The method as claimed in claim 22, wherein the request rejection message transmitted to the subscriber station further includes waiting time information for a period of time during which the subscriber station has to wait in order to re-transmit the request message.

25. The method as claimed in claim 22, wherein the dedicated time slot information is selected and allocated from among a contention-free access time area within an uplink transmission time area.

26. The method as claimed in claim 22, wherein the request message transmitted from the subscriber station to the base station is a handoff request message.

27. The method as claimed in claim 22, wherein the request message transmitted from the subscriber station to the base station is a bandwidth request message.

28. The method as claimed in claim 22, further comprising a step in which the base station determines whether to include the dedicated time slot information in the request rejection message according to information of service requested from the subscriber station.
